(19) United States
(12) Patent Application Publication
(10) Pub. No.: US 2026/0336977 A1
(43) Pub. Date: Oct. 29, 2026

(54) ELEVATOR CAR WITH AT LEAST ONE ELEVATOR BELT SLACK DETECTION UNIT ARRANGED ON ONE CAR SIDE WALL

(71) Applicant: Inventio AG, Hergiswil (CH)

(72) Inventors: Nilesh Thombare, Pune, MG (IN); Akshay Saste, Pune, Maharashtra (IN)

(21) Appl. No.: 18/997,197

(22) PCT Filed: Jul. 27, 2023
(86) PCT No.: PCT/EP2023/070797

§ 371 Date: Jan. 21, 2025

(30) Foreign Application Priority Data
Jul. 28, 2022 (EP) 22187560.2

(51) Int. Cl. B66B 7/12; B66B 19/06; G01L 5/10

(52) U.S. Cl. CPC B66B 7/1215; B66B 19/06; G01L 5/10

(57) ABSTRACT

An elevator has a car with at least one slack-detection-unit associated with a support means attached to the car. The slack-detection-unit is attached to a side wall of the car, in particular to a lower half or an upper half of the side wall and is connected to the support means.

### FIELD

The invention relates to an elevator. The elevator for transporting passengers or goods has an elevator car which can be moved up and down between floors in an elevator shaft via applying a force on a support means, which is attached to the elevator car.

### BACKGROUND

Slack-detection-units serve to detect slack support means. U.S. Pat. No. 6,123,176 presents a device for monitoring a support means tension in an elevator. The device, as common in other prior art, is attached to an end portion of the support means at the top of the elevator car and/or at a top of a counterweight. Such an arrangement leads to increased need of end portion space in the elevator shaft, as it increases the distance between the car top and the support means end.

There may be a need, among other things, for an improved/alternative device for slack detection, which requires less elevator shaft space. In particular, there may be a need to be able to monitor support means for slack in an automated, reliable manner without an increased need of elevator shaft space.

### SUMMARY

It is an object of the present invention to avoid the disadvantages of the known and, in particular, to provide an improved elevator. In particular, the elevator is to be installable in buildings having shallow pit/head depths. The elevator is to be characterized by a small space requirement and compact design, while at the same time offering a reliable slack detection.

According to the invention, these and further tasks are solved with the elevator having the features described below. The elevator comprises a car. At least one slack-detection-unit associated with a support means is attached to the car. Preferably the slack-detection-unit is attached to a sidewall of the car, in particular it is attached to a lower half or upper half of the sidewall. The slack-detection-unit is connected to the support means.

The connection of the at least one slack-detection-unit to the suspension means at the sidewall of the car generally results in the slack-detection-unit or slack-detection-units being located outside the vertical projection of the elevator car with respect to the car body.

Attaching it to the sidewall decreases the used vertical shaft space. Overall, the elevator is inexpensive yet effective in terms of safety.

In preferred embodiment, the support means is guided to a suspension point at the slack-detection-unit for suspending the elevator car from the floor, which suspension point/slack-detection-unit is positioned at the car floor of the elevator car.

In a preferred embodiment, the elevator car is exclusively suspended on the at least one slack-detection-unit.

In such an elevator the slack-detection-unit serves to exclusively suspend the car and to detect a slack support means at the same time, reducing the space needed compared to prior art solutions. The fact that the slack-detection-unit is connected to a support means for carrying the elevator car and thus is used as support means suspension point allows for a spatial efficiency.

The elevator preferably comprises two suspension means, resulting in an advantageous weight compensation. In this case, the elevator may comprise an elevator car supported by two support means, wherein the support means for suspending the elevator car on the floor side are guided to each a suspension point arranged on opposite sides of the elevator car, which suspension points are positioned on the car floor of the elevator car. The elevator consequently has two slack-detection-units, each unit being connected to a respective suspension means.

Preferably, in the elevator as described above and in the following, the slack-detection-unit includes a slack-sensor, which slack-sensor is, preferably directly, connected to the support means to detect changes in the tension of the support means.

Such a sensor might be implemented as a simple switch, which depending on the tension within the support means may be on or off. Additionally, or alternatively, the sensor may be implemented as a strain gauge, allowing to derive an actual tension within the support means.

In another embodiment of the elevator described above and in the following, the slack-detection-unit further includes a lever, which lever is arranged to transmit a movement of the support means on to the slack-sensor.

The lever allows the separation of the suspension point of the support means and the slack-sensor by diverting at least a portion of the force executed from the support means on to the suspension point onward to the slack-sensor. This way the slack-sensor does not have to be dimensioned for the full suspension force.

Preferably, the slack-sensor is a male-female-contact-bridge comprising a female or male contact attached to the support means or the lever and a respective male or female contact attached to the car.

A female-male-bridge is an advantageously kind of contact, especially suitable for a rough environment as it is to be expected at an elevator suspension (e.g. with high levels of vibrations and dirt).

In a further embodiment, the respective slack-detection-unit comprises a buffer, preferably a rotationally symmetrical, preferably cylindrical, buffer, preferably surrounded by hollow-cylindrical housing body and whereas the support means or a support means connecting piece adjoining the support means is connected, preferably directly, to the buffer and preferably guided through the buffer. The buffer body can have a corresponding cavity for the passage of the support means or support means connecting piece.

The slack-detection-unit in other words serves to cushion the elevator car. The buffer can be positioned above a suspension point. The buffer is preferably arranged in the vertical projection of the suspension point, with the suspension means and the buffer associated therewith being particularly preferably coaxial with one another.

The buffer in the suspension point is to provide for damping vibrations generated by the drive and transmitted to the car by the support means.

Instead of a hollow cylinder, other shapes for the buffer body are also conceivable. For example, the buffer could also have a conical outer contour. Thanks to the buffer body, vibrations coming from the drive or the support means can be effectively damped. Such buffer bodies can be easily and inexpensively procured and adapted according to requirements.

The buffer body can be made of an elastomer. The buffer body can be made of rubber. It can also be a spring.

An end part may be fixed to the free end of the support means or to the support means connecting piece and may bear directly or indirectly against the buffer body. The end part can, for example, be a threaded nut that is screwed onto a support means connection piece comprising a threaded rod and is preferably secured by means of appropriate securing means.

With regard to operational safety and durability, it can be advantageous if the buffer has an impact element. The impact element can preferably be made of a metallic material, for example steel.

The impact element is an element via which compressive forces to be damped by the buffer can be introduced into the buffer body during touchdown. The impact element protects the buffer body against wear.

The impact element can, for example, be made from a metal plate by means of a forming process.

The support means can be attached to the impact element. The vibrations of the support means are transmitted to the buffer body via the impact element. The end part can rest on and be supported by the impact element.

The impact element may have a central cavity complementary to the cavity of the buffer body for reception of the support means or the support means connection piece, so that the impact element can be placed right at the buffer.

In an embodiment of the elevator the impact element is partially or fully implemented by the lever, which is directly or indirectly connected to the buffer.

The function of the impact element (protection of the buffer) and the lever (diverting at least a part of the suspension force on to the slack sensor) can thus be combined spatial effective in one piece.

The support means can be one or more belts. Supporting belts have the advantage that, thanks to the belts, space can be used optimally and are particularly suitable for space-saving designs. Alternatively, the support means could be formed by one or more ropes.

Another aspect of the invention relates to the use of a slack-detection-unit to attach a support means to a sidewall of an elevator car. Alternatively formulated, the elevator car according to the invention may comprise at least one slack-detection-unit from which or via which the elevator car may be suspended. In other words, the slack-detection-unit(s) provide the suspension point(s) and are thus an integral part of the suspension points. The slack-detection-unit(s) have a dual function. On the one hand, they allow the detection of a slack rope, as do conventional slack contacts; on the other hand, they now also serve to support or suspend the elevator car.

### DESCRIPTION OF THE DRAWINGS

Further individual features and advantages of the invention will be apparent from the following description of an embodiment and from the drawings. Showing:

FIG. 1 a simplified side view of an elevator according to the invention,

FIG. 2 an enlarged and sectional view of the side view of FIG. 1; and

FIG. 3 a simplified perspective view of a male-contact shown in FIG. 2.

### DETAILED DESCRIPTION

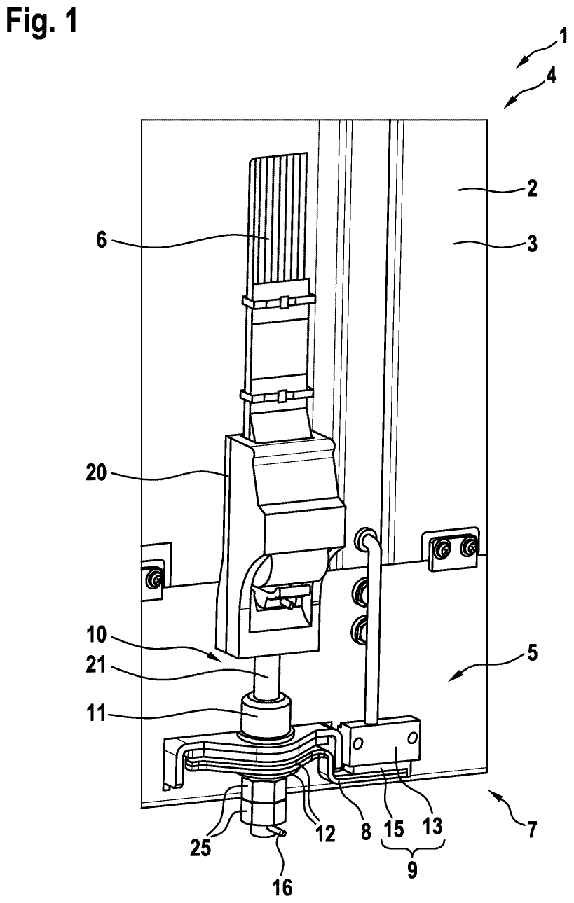

FIG. 1 shows an elevator 1 for a multi-story building. The building has an elevator shaft (not shown). The elevator 1 contains an elevator car 2, which can be moved vertically up and down in the elevator shaft for transporting people or goods to individual floors (not shown). The elevator car 2 has side walls 3 and a car floor 7, which form a generally cuboid-shaped car body.

The elevator car 2 is moved by means of support means designated 6, from which the car 2 is suspended; the support means 6 can be one or more belts. However, suspension ropes are also conceivable as support means 6. The support means 6 are connected to a drive (not shown) to move the car 2.

For structural or other reasons, there may be too little space for a conventional elevator with a shaft pit and a shaft head. Known and common are special elevators with low shaft pits with pit depths smaller than 60 cm and preferably smaller than 35 cm. The elevator 1 shown here and explained in detail below is particularly well suited for such elevator systems with shaft pits having low pit depths or for pitless elevators.

The elevator 1 may further comprise at least one counterweight (not shown) connected to the elevator car 2 and movable up and down in the opposite direction to the elevator car 2. The elevator car 2 and the at least one counterweight are moved along (not shown) vertical guides. Generally, such elevators have only one drive, for example a traction sheave drive, with which the support means are driven and thus the elevator car and the counterweight are moved in opposite directions.

However, the elevator 1 can also have two counterweights and two drives. Each of the support means 6 is connected to one of the two counterweights. The elevator 1 may have special guide rails with which both the elevator car 2 and the respective counterweights are linearly guided. The guide rails may be manufactured as one-piece rolling profiles. Such an elevator 1 may be designed as a so-called “front bag elevator”. Further details on the front bag elevator and on the guide rails of the elevator car 2 and the counterweights with common guide rails can be found in WO 2020/127303 A1 and WO 2020/127787 A1.

For suspension of the elevator car 2 in the floor region, the support means 6 are guided to suspension points 10 (only one of the two suspension points is visible in the figure) arranged on opposite sides of the elevator car 2, which are positioned on the lower half 4 of the side wall 3 (alternatively on the upper half of the side wall 3, not shown), at the bottom region of the car 2. The suspension points 10 and thus also the slack-detection-unit 5 are located outside of the vertical projection of the elevator car 2 with respect to its car body, which is defined by the car side walls 3.

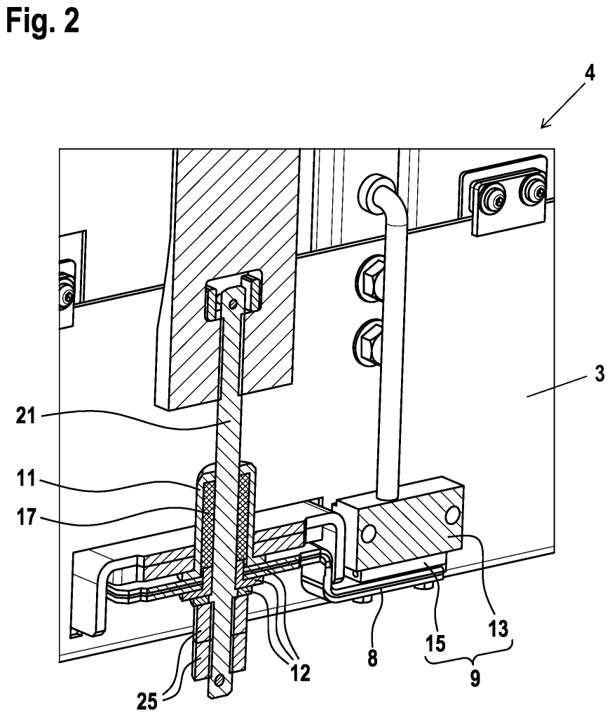

Constructional details of the special design of the slack-detection-unit 5 for suspending the elevator car 2 can be seen in FIG. 2. The suspension point 10 is defined by the slack-detection-unit 5, which has a hollow cylindrical body 11. The body 11 can be designed as a one-piece and can be made of metal.

The support means 6 or, more precisely, a support means connection piece 21 adjoining the support means 6 is guided through the buffer body 17 as shown in FIG. 2. The buffer body 17 is preferably rotationally symmetrical. Buffers 17, each assigned to a slack-detection-unit 5 and thus to a support means 6, are integrated in the slack-detection-units 5 for temporarily supporting the elevator car 2 relative to the shaft floor during any travel. Each buffer 17 is connected directly or indirectly to one of the support means 6. The elevator car 2 is thus suspended from or via the buffers 17, whereby damping of the elevator car 2 during a car ride is achieved thanks to the buffers 17. The vibrations generated by the drive and transmitted to the car 2 by the support means 6 can thus be easily reduced, resulting in good ride comfort. The buffer 17 can be designed as a one-piece molded body and can be made of rubber or a plastic, in particular an elastomer.

The support means 6 is equipped at the end of the car with a support means end connection 20 (as shown in FIG. 1), to which a support means connection piece 21 is connected. The suspension means end connection 20 can be a suspension means end connection such as has become known by way of example from WO 03/022723 A1 or EP 2 261 162 A1. The load-bearing means connection piece 21 has a threaded rod. Two end parts 25 are each formed by a nut and are located at the free end of the suspension means connection piece 21. A securing device 16 is provided for securing the end part 25.

The slack-detection-unit 5 further comprises one or several impact elements 12 preferably made of a metallic material. The impact element 12 contacts the end part 25 (or optionally a metallic counterpart attached to the end part 25). The support means 6 is attached to the impact element 12 via the end part 25. The end part 25 rests on and is supported by the impact element 12. During car travel, the vibrations or oscillations of the support means 6 are introduced into the buffer 17 via the impact element 12.

The impact element 12 has a step-like shape, whereas a first part of it is acting as the impact element 12 and whereas the second part is connected to a male-contact 15, which builds a contact with a respective female-contact 13 attached to the side wall 3 of the car.

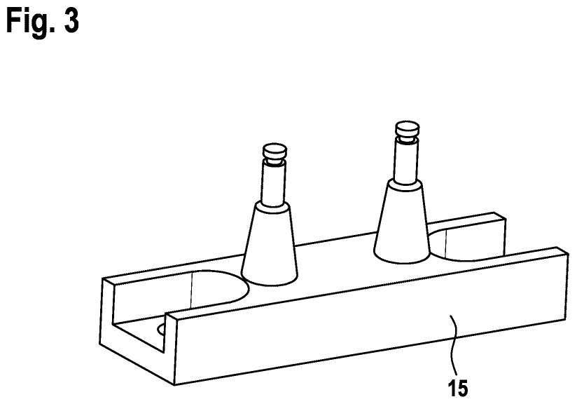

FIG. 3 shows the male-contact 15 of the slack-detection-unit 5. As shown in FIG. 1 and FIG. 2, the female-contact 13 and the male-contact 15 form a slack-sensor 9 as a male-female-contact bridge 9 of the slack-detection-unit 5. The slack-detection-unit 5 further includes a lever 8, which lever 8 is arranged to transmit a movement of the support means 6 on to the slack-sensor 9. The female-contact 13 is attached to the lower half 4 of the car side wall 3 and the male-contact 15 is attached to the lever 8, but the contacts 13, 15 could be reversed.

In accordance with the provisions of the patent statutes, the present invention has been described in what is considered to represent its preferred embodiment. However, it should be noted that the invention can be practiced otherwise than as specifically illustrated and described without departing from its spirit or scope.

1-12. (canceled)

13. An elevator comprising:
an elevator car having a side wall;
a support means for suspending the car; and
a slack-detection-unit attached to the car side wall and connected to the support means.

14. The elevator according to claim 13 wherein the slack-detection-unit is attached to a lower half of the car side wall.

15. The elevator according to claim 13 wherein the elevator car is adapted to be suspended on the slack-detection-unit by the support means.

16. The elevator according to claim 13 whereas the slack-detection-unit includes a slack-sensor connected to the support means, the slack-sensor adapted to detect changes in a tension of the support means.

17. The elevator according to claim 16 wherein the slack-detection-unit includes a lever arranged to transmit a movement of the support means to the slack-sensor.

18. The elevator according to claim 17 wherein the slack-sensor is a switch actuated by the lever.

19. The elevator according to claim 18 wherein the switch is a male-female-contact-bridge including one of a female-contact and a male contact attached to the lever and another of the female-contact and the male-contact attached to the car.

20. The elevator according to claim 13 wherein the slack-detection-unit includes a buffer and the support means, or a support means connection piece adjoining the support means, is connected to the buffer.

21. The elevator according to claim 20 wherein the slack-detection-unit has a hollow cylindrical body and the buffer has a cylindrical buffer body surrounded by the hollow cylindrical body of the slack-detection-unit, and wherein the support means or the support means connection piece is connected to the buffer body.

22. The elevator according to claim 21 wherein the support means connection piece is guided through the buffer body.

23. The elevator according to claim 21 wherein the buffer body is made of an elastomer material or a rubber material.

24. The elevator according to claim 20 including an end part fixed to a free end of the support means, the end part bearing directly or indirectly against the buffer.

25. The elevator according to claim 20 wherein the buffer includes an impact element attached to the support means.

26. The elevator according to claim 25 wherein the impact element is made of a metallic material.

27. The elevator according claim 25 wherein the slack-detection-unit includes a slack-sensor connected to the support means, the slack-sensor detecting changes in a tension of the support means, wherein the slack-detection-unit includes a lever arranged to transmit a movement of the support means to the slack-sensor, and wherein the impact element includes the lever, the lever being directly or indirectly connected to a body of the buffer.

28. The elevator according to claim 13 wherein the support means are belts.

29. A method for connecting a support means to an elevator car having a side wall, the method comprising steps of:
attaching a slack-detection-unit to the car side wall, the slack-detection-unit including a slack-sensor adapted to detect changes in a tension of the support means; and
connecting a free end of the support means to the slack-detection-unit.
